(19) United States
(12) Patent Application Publication
(10) Pub. No.: US 2004/0240201 A1
(43) Pub. Date: Dec. 2, 2004

(54) FLASHLIGHT

(76) Inventor: Peter Rausseck, Bretten (DE)

Correspondence Address: HARNESS, DICKEY & PIERCE, P.L.C., P.O. BOX 828, BLOOMFIELD HILLS, MI, 48303, US

(21) Appl. No.: 10/481,974

(22) PCT Filed: May 24, 2002
(86) PCT No.: PCT/EP02/05735

(30) Foreign Application Priority Data
Jun. 29, 2001 (DE) 101 31 686.0

(51) Int. Cl. F21L 19/00

(52) U.S. Cl. 362/171

(57) ABSTRACT

A pocket lamp consisting of a base body (10) and a lamp head (12) with at least two luminous diodes (32a, 32b), each of which having an optical device (44a) associated with one of said luminous diodes (32a, 32b) (44a), said optical device being used to focus the light radiated by the respective luminous diode, and respectively one tube body (56a, 56b, 56c) disposed between one of the luminous diodes (32a, 32b) and the associated optical device (44a) for focussing the light radiated by the respective luminous diode. The tubes (56a, 56b, 56c) are embodied in such a way that substantially prevent light from one of the luminous diodes from penetrating into (32a, 32b) an optical device for focussing the light radiated by the respective luminous diode associated with one of the other luminous diodes (32a, 32b).

A lighting device is described in U.S. Pat. No. 4,963,798 which can be designed for use as a portable lamp or also as a fixedly installed lamp. The lighting device has two or more light sources which emit light in different spectral ranges. Parameters of an electrical circuit supplying the light sources are set such that the spectral energy distribution of beams of illumination, which serve for the illumination of objects and surfaces, can be shaped such that, on the one hand, the perception and discrimination by an observer of information displayed on the objects and surfaces can be improved and, on the other hand, the radiation in undesired spectral ranges is reduced. A flashlight is in particular described which has an incandescent lamp arranged in a reflector as well as light emitting diodes for red and green colors arranged in ring shape about the incandescent lamp. The incandescent lamp and the light emitting diodes are covered by a plate-shaped cover lens.

A flashlight (torch) is described in GB 810,256 which has a bulb, a lens which has a central convex section and an annular planar section surrounding it, a reflector which serves to focus rays from the incandescent lamp through the annular section of the lens in a substantially collimated light beam, and an opaque cover. The cover is displaceable in the direction of radiation in order to alternatively allow light radiated from the incandescent light to be incident onto the reflector or to cover it with respect to the radiated radiation.

A lamp, in particular a flashlight, is described in DE 200 943 U1 having a plurality of light sources. All light sources are light emitting diodes which are arranged next to one another in each case centered in a reflector surrounding the respective light emitting diode. The reflectors are connected in honeycomb-like manner to form a body in one piece. Light emitted by the light emitting diodes is directed by the reflectors directly to objects to be illuminated.

The object is satisfied by a flashlight having the features of claim 1.

A flashlight in accordance with the invention has a flashlight base body and a lamp head. This lamp head includes at least two light emitting diodes and in each case one optical device for the focusing of the light radiated from the respective light emitting diode and associated with the light emitting diodes. The devices for the focusing of the light radiated by the respective light emitting diode can in particular be converging lenses such as plano-convex lenses or bi-convex lenses.

To achieve a less inhomogeneous light pattern at a larger distance, a tube is arranged in each case between one of the light emitting diodes and the associated optical device for the focusing of the light radiated from the respective light emitting diode. The tubes are designed such that they each largely prevent penetration of light of one of the light emitting diodes into an optical device associated with another of the light emitting diodes for the focusing of the light radiated from the respective light emitting diode.

It is prevented by the tubes in accordance with the invention that scattered light of a light emitting diode is incident into optical devices for the focusing of the light radiated from other light emitting diodes and, after deflection by these, results in comparatively weakly lighted regions in the light pattern produced by the flashlight at a larger distance. A focusing of the light radiated by the light emitting diodes can therefore hereby be achieved without a simultaneous impairment by scattered light from adjacent light emitting diodes such that a light pattern with a high illumination intensity, but only low inhomogeneities, is obtained at a larger distance.

Preferred embodiments and further developments of the invention are described in the description, in the drawings and in the dependent claims.

The tubes are preferably designed such that the light exiting them from the corresponding light emitting diodes is substantially completely incident onto the corresponding associated optical device for the focusing of the light radiated from the respective light emitting diode. This means that the light entrance surface of the image producing device may not be considerably smaller than the opening surface of the tube. The tube hereby acts as an aperture diaphragm, whereby regions result in the light pattern at a larger distance which are sharply delineated with a corresponding focus and which are associated with the light emitting diodes. This results, on the one hand, in a larger illumination intensity in the light pattern with respect to the light amount radiated by the light emitting diodes, since scattered light is avoided. On the other hand, a more pleasant and more appealing light pattern results for the user due to the sharp delineation.

The tubes are preferably produced from a non transparent or translucent material, with it generally also being sufficient, however, for the inside surface or the outside surface of the tubes to be coated in a non light transmitting manner in each case. The inner surface of the tubes is particularly preferably non reflective, with a pure light scattering admittedly being possible, but preferably being likewise greatly reduced. The surface of the tubes is particularly advantageously matted for this purpose, since this is easy to produce.

Although the tubes can generally also only be formed by intermediate walls and by the housing of the lamp head, the inner space of at least one of the tubes is made rotationally symmetrical. This cross-section of the inner space corresponds, on the one hand, to the radiation characteristics of the light emitting diodes and results, on the other hand, in a very appealing lighting pattern, because it is circular. Furthermore, such tubes are particularly simple to manufacture. To be able to focus as much as possible of the light radiated by a light emitting diode, as a rule the optical device associated with this light emitting diode for the focusing of its light is larger in surface than the associated light emitting diode. It is therefore particularly preferably preferred for at least a part section of the inner space of the tubes to have the form of a truncated cone.

Although the tubes should generally only be located between the light emitting diode and the optical device for the focusing of the light radiated by it associated with this light emitting diode and although they can in particular be shorter than the spacing between the light emitting diode and the device associated with it for the focusing of the light radiated by it, it is preferred for the tubes to be held on a base element and for their ends facing the light emitting diodes to at least receive parts of the luminous body of the light emitting diodes. A plurality of advantages are simultaneously achieved by this type of holding of the tubes. On the one hand, a particularly simple assembly of the tubes results, whose position relative to one another can be ensured simply by the arrangement on the base elements such that their alignment to the optical devices for the focusing can be carried out for all tubes with only one adjustment procedure. On the other hand, since the ends facing the light emitting diodes at least receive parts of the luminous bodies of the light emitting diodes, the light emitting diodes which are as a rule only held by their contact pins can be aligned easily and precisely. A particularly good alignment of the light emitting diodes to the optical device for the focusing of the light radiated by the respective light emitting diode and thus a high illumination intensity hereby results.

An end of at least one tube associated with a light emitting diode is particularly preferably adjacent to the optical device for the focusing of the light radiated by this light emitting diode associated with this light emitting diode or to an element holding it. In addition to the alignment of the light emitting diodes to the corresponding optical devices for the focusing of the light radiated by the respective light emitting diodes, a simple adjustment hereby results of the spacing between the light emitting diodes and the optical devices for the focusing of their light, whereby a good focusing of the light radiated by the light emitting diodes can easily be achieved in pre-determined distance regions. This effect can generally also be achieved by a corresponding shaping of the base element, for example by molded spacers; however, at least in the case in which the ends of all tubes are adjacent to the corresponding optical devices for the focusing of the light radiated by the light emitting diodes, the further advantage results that, due to reflection at the optical devices for the focusing of the light radiated from the respective light emitting diodes, scattered light can also not easily be incident into the interior of the lamp head between the tubes and be reflected from there such that unwanted scattered light arising in this manner is suppressed.

The base element and the tubes are preferably made in one piece, which permits a simple and cost-favorable manufacture, for example as a plastic injection molded part, on the one hand, and also ensures a stable alignment of the tubes toward one another, particularly also with respect to disturbances, on the other hand. The base part particularly preferably has substantially the shape of a light collecting reflector in this process, whereby a very stable holding of the tubes results, on the one hand, since they are connected to the base part along their periphery and also in their longitudinal direction. On the other hand, when observed against the lighting direction, an image results which is appealing and is known from customary flashlights.

It is furthermore preferred for the optical devices for the focusing of the light radiated from the respective light emitting diodes to be arranged inclined with respect to one another such that beams formed in each case by the optical devices of light radiated by the light emitting diodes intersect in a pre-determined region. For this purpose, in particular in the case that lenses are used as the optical devices for the focusing of the light radiated by the respective light emitting diodes, the optical axes of said lenses can be inclined toward one another in the radiation direction. The pre-determined region can, for example, be given by a typical working distance of the flashlight from an object to be illuminated, for example between 5 and 10 m, or by the illumination intensity of the light emitting diodes. Not only a larger illumination intensity hereby results in the predetermined region, but also a better delineated and more homogeneous light pattern. The inclination of the optical axes and the position and the focal length of the lenses are particularly preferably selected such that the map of the light emitting diodes lies in the intersectional region of the beams. A circle then substantially results as the illumination pattern in the pre-determined region without irritating reflections which surround the circle.

The light emitting diodes are preferably held on a printed circuit board which has contact elements for contacting live contacts provided in the flashlight base body or batteries or rechargeable batteries which can be inserted into the flashlight base body. A particularly simple holding of the light emitting diodes hereby results, with the current paths simultaneously being able to be particularly short.

The contact elements particularly preferably include a first ring-shaped contact surface and a second, substantially ring-shaped or circular further contact surface arranged inside the first contact surface. This permits a reliable contact even at different angular positions of the flashlight base body and the lamp head which can in particular occur when the lamp head is screwed onto the flashlight base body. Furthermore, it is also possible to use the contacts of batteries arranged next to one another in the flashlight base body as live contacts.

When a printed circuit board is used which supports the light emitting diodes, it is preferred for the base element to be arranged on the printed circuit board since a compact arrangement of the components hereby results, on the one hand, and possible damage to the power feeds for the light emitting diodes can easily be avoided by a relative movement of the base elements and of the printed circuit board, on the other hand.

Although the optical devices for the focusing of the light radiated from the respective light emitting diodes can generally be held individually in corresponding holders, it is preferred for the optical devices for the focusing of the light radiated by the respective light emitting diode to be lenses which are integrated in a front element. The front element can be translucent or opaque in the regions without lenses, which can be achieved by corresponding coatings, but is preferably transparent in total, since it can then be manufactured very easily e.g. as a plastic injection molded body and cost favorably. A simple alignment to all light emitting diodes is furthermore possibly by only one adjustment procedure, in particular when a lamp head is used with a base element as was described above.

The lenses can particularly preferably be formed as plano-convex lenses whose plane surface respectively forms a region of the outer side of the front element. In another particularly preferred embodiment, the lenses are formed as biconvex lenses which can have, with the same focal length and thus the same light collecting effect, lower radii of curvature and are therefore easier to manufacture.

Although the front element can substantially only be made in disk form, it is made in cup form in a preferred embodiment, with the tubes and the printed circuit board with the light emitting diodes being arranged in the cup interior. A unit which is easy to assemble with all optical components thereby results, with a unit which is very simple to assemble with very reliable and simple adjustment being able to be manufactured, in particular in the event that a base element is provided.

For this purpose, the front element and the base element or the printed circuit board have appropriate guide elements which act as security against rotation. A very simple assembly hereby results, on the one hand, since the alignment of the light emitting diodes, of the tubes and of the optical devices for the focusing of the light radiated by the respective light emitting diodes is ensured solely by the guide elements. On the other hand, no maladjuments can result during use e.g. by judders or vibrations by a relative rotation of the light emitting diodes and of the optical devices associated with them for the focusing of the light radiated by the respective light emitting diodes.

On assembly, the base element can be simply introduced into the cup-shaped front element, whereupon the cup is closed by the printed circuit board at its rim. The connection between the front element and the printed circuit board can take place in this process e.g. by bonding or, when plastic parts are used, also by weld joints; however, it is preferred for the front element and the printed circuit board to be connected to one another by a snap connection at the rim of the cup. A particularly simple assembly hereby results in which moreover no high temperatures which may damage the printed circuit board or the light emitting diodes or damaging solvent vapors which may be contained in adhesives can occur.

The front element with tubes and printed circuit board is preferably arranged in a sleeve-like head housing, whereby a simply assembly of the units is possible. Moreover, the sleeve-like head housing can serve as mechanical protection for the front element by a corresponding material choice.

To permit use of the flashlight in accordance with the invention even when damp and wet, preferably at least one lamp head seal, particularly preferably a peripheral lamp head seal, is provided between the front element and the head housing and prevents penetration of moisture between the front element and the head housing.

For this purpose, it is also preferred to provide a sealing, in particular a peripheral sealing, between the lamp head and the flashlight base body.

To achieve an illumination which is as uniform as possible, the light emitting diodes are preferably arranged on a circle at equal angular intervals.

Three light emitting diodes are preferably provided, sine a particularly favorable ratio hereby results between achieved illumination and still low power consumption. This is in particular of large importance, because a low power consumption with equal burn time also permits the use of smaller batters or rechargeable batteries and thus a lower weight.

A preferred embodiment will now be described by way of example with reference to the drawings. There are shown:

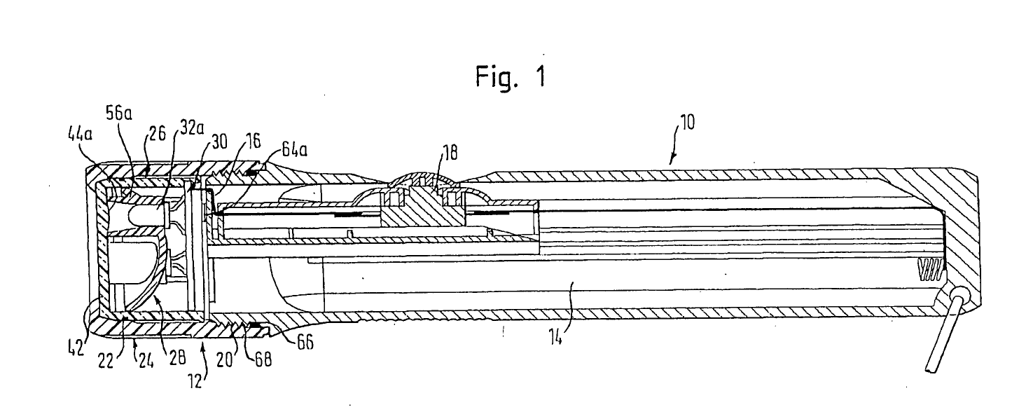

FIG. 1 a schematic sectional view through a flashlight in accordance with a preferred embodiment of the invention;

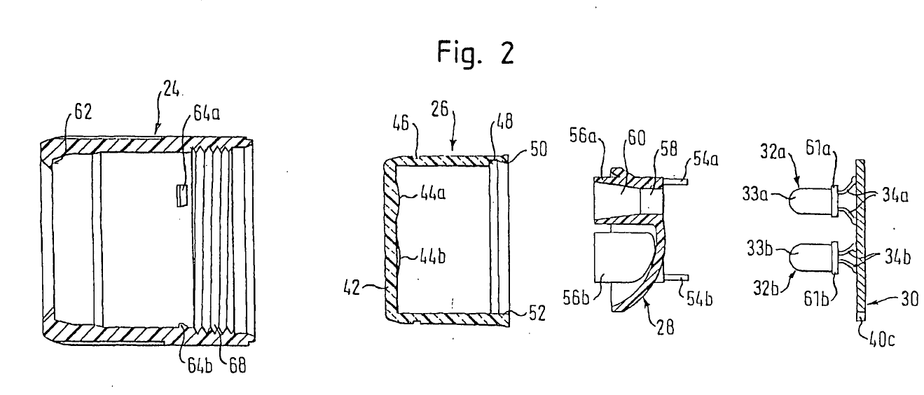

FIG. 2 an exploded view of the lamp head of the flashlight in FIG. 1;

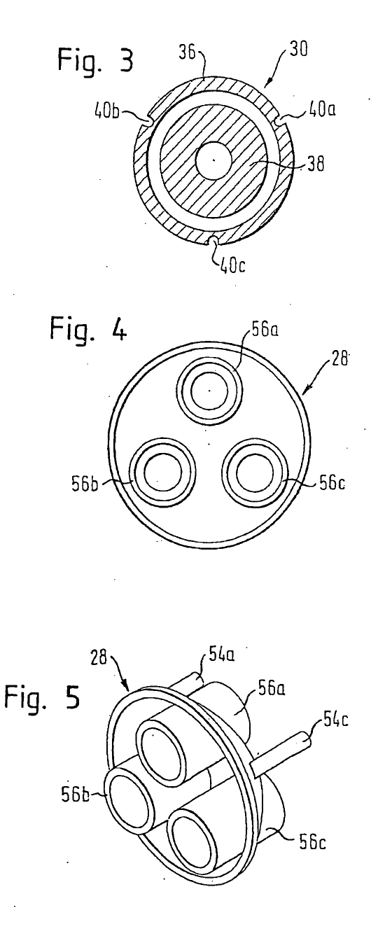

FIG. 3 a plan view of the printed circuit board in the lamp head in FIG. 2 from the side facing the flashlight base body;

FIG. 4 a plan view of the base element of the lamp head in FIG. 2 from a direction opposite to the illumination direction; and

FIG. 5 a perspective view of the base element in FIG. 4.

In FIG. 1, a flashlight in accordance with a preferred embodiment of the invention includes a flashlight base body 10 and a lamp head 12.

The flashlight base body 10 is made in tubular shape, with it being closed at one end. A battery compartment 14 for the reception of batteries is formed in the interior space. Furthermore, current carrying contacts are provided in the flashlight base body 10, of which only the current carrying contact 16 is visible in FIG. 1. This current carrying contact 16 is connected via a water-tight switch 18 let into the flashlight base body 10 having a contact surface not shown in the Figures for a pole of a batter which can be inserted into the batter compartment 12.

At its open end, the flashlight base body 10 has an external thread 20 which serves for the fastening of the lamp head 12. A peripheral lamp head seal 22 held in a recess is provided at the end of the external thread 20.

As also shown in FIG. 2, the lamp head 12 is comprised of a sleeve-like head housing 24, a front element 26, a base element 28 and a printed-circuit board 30 with three white light emitting diodes, of which only the light emitting diodes 32a and 32b are shown in FIG. 2.

As visible in FIG. 3, the printed circuit board 30 is circular, with the three light emitting diodes, not visible in the drawing, being arranged on a circle at equal angular distances from one another. As shown in FIG. 2 for the light emitting diodes 32a and 32b, the light emitting diodes have luminous bodies 33a and 33b and are held by their contact pins 34a and 34b on the printed circuit board 30. On the rear side remote from the side supporting the light emitting diodes, the printed circuit board has a first contact surface 36 made in circular shape as well as a second contact surface 38 which is likewise of ring shape and is arranged concentrically in the first contact surface 36. These contact surfaces 36 and 38 are connected via conductor tracks not shown in the Figures and via electronic components to the light emitting diodes such that current from the batteries inserted into the flashlight base body can be supplied to the light emitting diodes via the contact surfaces 36 and 38 after contacting the power feed contacts in the flashlight base body 10.

Furthermore, three recesses 40a, 40b and 40c are provided at equal angular intervals along the periphery of the printed circuit board 30.

The front element 6 is made in cup shape and produced from a transparent material such as a from an appropriately transparent plastic. There are integrated in its front lens 42 three converging lenses at equal angular intervals on a circle in accordance with the arrangement of the light emitting diodes, of which only the converging lenses 44a and 44b are visible in FIG. 2. The curvatures of the converging lenses are formed on the inner side of the cup such that the outwardly extending side of the front lens 42 is planar.

A peripheral groove 46 for the acceptance of a seal is formed close to the front lens 42 at the side wall of the front element 26.

A shoulder 48 extends along the cup rim offset in the direction of the front lens 42. The cup rim is thickened to a bead 50 extending into the interior of the cup, with the shoulder 48 extending further into the cup interior than the bead 50 and the spacing between the shoulder 48 and the bead 50 corresponding to the thickness of the printed circuit board 30. The interior diameter of the front element 26 in the region of the shoulder 48 and in the region of the bead 20 are selected such that the printed circuit board 30 can be snapped in with pressure between the bead 50 and the shoulder 48.

At the interior rim of the front element 26, three guide noses are furthermore provided at equal angular spacings, of which only one guide nose 52 is visible in the Figures and which are made such that they engage into the corresponding recesses 40a, 40b and 40c along the periphery of the printed circuit board 30 when it is inserted into the front element 26. The converging lenses and the guide noses in the front element 26 and the recesses 40a, 40b and 40c and the light emitting diodes in or on the printed circuit board 30 are aligned to one another in this process such that the light emitting diodes are aligned onto the convergent lenses when the guide noses engage into the recesses of the printed circuit board.

The base element 28, which is held in the front element 26 by the printed circuit board 30 snapped into the front element, has a paraboloid-like basic shape and sits on the printed circuit board 30 with three support legs 54a, 54b and 54c (cf. FIG. 2 and FIG. 5) arranged at equal angular intervals. As can be recognized in FIGS. 4 and 5, three tubes 56a, 56b and 56b are furthermore formed in the base element 28 arranged on a circle at equal angular intervals to one another. The tubes 56a, 56b and 56c and the base element 28 with the support legs 54a, 54b and 54c are made in one piece as a plastic injection molded part of a non-transparent plastic.

Since the contact line extends in accordance with the curvature of the base element 28 between the base element 28 and the tubes 56a, 56b and 56c also in the longitudinal direction of the tubes, they are held at the base element 28 in the longitudinal direction.

The tubes 56a, 56b and 56c are formed substantially the same so that they will be described in the following more precisely for the example of the tube 56a.

The tube 56a has a cylindrical external surface (cf. FIGS. 4 and 5) and contains a rotationally symmetrical interior space. The interior space has a cylindrical section 57 at its end facing the light emitting diode 32a for the acceptance of the luminous body 33a of the light emitting diode 32a. A widening, section 60 of truncated cone shape of the interior space of the tube adjoins this. Whereas the interior diameter of the cylindrical section 58 corresponds to the external diameter of the luminous body 33a of the light emitting diode 32a, the interior diameter of the tube at the end facing the front lens 42 or facing the lens 44a is selected in accordance with the diameter of the lens 44a.

The length of the support legs 54a, 54b and 54c is selected such that the ends of the tubes 56a, 56b and 56c at the light emitting diode side sit on sockets 61a, 61b of the light emitting diodes, whereby the luminous bodies 33a, 33b of the light emitting diodes are held in a defined position at the tube end. The length of the tubes 56a, 56b and 56c is furthermore selected such that they abut the front lens 42, whereby it is ensured, on the one hand, that the luminous bodies of the light emitting diodes are located at a defined spacing from the converging lenses 44a, 44b, with the spacing and the focal length of the converging lenses being selected, for example, such that the light of the light emitting diodes is focused at a spacing of approximately 5 m. On the other hand, a movement of the base element 28 between the front lens 42 and the printed circuit board 30 snapped into the front element 26 is prevented.

The front element 26 with the inserted base element 28 and the printed circuit board 30 form, when the latter is snapped into the front element, a unit which is easy to handle and which contains all the technical light components of the flashlight. Light radiated from the light emitting diodes (32a, 32b in FIG. 2) is guided by the tubes 56a, 56b and 56c onto the corresponding converging lenses (44a, 44b in FIG. 2) and focused by these without scattered light from a light emitting diode being able to be incident onto a converging lens associated with another light emitting diode and being able to be deflected thereby.

The sleeve-like head housing 24 has a peripheral projection 62 at its front end and three latch noses arranged along the interior surface at equal angular distances, of which only the latch noses 64a and 64b are visible in FIG. 1. The unit of front element 26, base element 28 and printed circuit board 30 has been inserted into the head housing 24, with it abutting the projection 62 at the front lens 42 and being snapped behind the latch noses at the rim remote from the front lens 42 (cf. FIG. 1). It is hereby held very simply and securely in the head housing 24.

As shown in FIG. 1, a seal 66 is arranged in the groove 46 of the front element 26 and prevents a penetration of moisture through the gap between the front plate 42 and the projection 62 into the interior of the lamp head 12 and thus into the flashlight base body 10.

The head housing 24 furthermore has an internal thread 68 with which the head housing 24 or the total lamp head 12 can be screwed onto the external thread 20 of the flashlight base body 10. The end of the head housing 24 at the thread side is formed in this process such that the lamp head seal 22 arranged at the end of the external thread 20 of the flashlight base body 10 sealingly closes the gap between the lamp head 12 and the flashlight base body 10 when the lamp head is screwed on.

### REFERENCE SYMBOL LIST

10 flashlight base body

12 lamp head

14 battery compartment

16 power feed contact

18 switch

20 external thread

22 lamp head seal

24 head housing

26 front element

28 base element

30 printed circuit board

32a, 32b light emitting diodes

33a, 33b luminous bodies

34a, 34b contact pins

36 first contact surface

38 second contact surface

40a, 40b, 40c recesses

42 front lens

44a, 44b converging lenses

46 groove

48 shoulder

50 bead

52 guide nose

54a, 54b, 54c support legs

56a, 56b, 56c tubes

58 cylindrical section of the interior space

60 truncated cone shaped section of the interior space

61a, 61b socket

62 projection

64a, 64b latch noses

66 seal

68 internal thread

1-20. (Cancelled)

21. A flashlight with a flashlight base body (10) and a lamp head (12) having
at least two light emitting diodes (32a, 32b);
in each case one optical device (44a, 44b) for the focusing of the light radiated from the respective light emitting diode (32a, 32b) and associated with one of the light emitting diodes (32a, 32b); and in each case a tube (56a, 56b, 56c) arranged between one of the light emitting diodes (32a, 22b) and the associated optical device (44a, 44b) for the focusing of the light radiated from the respective light emitting diode,
wherein the tubes (56a, 56b, 56c) are designed such that they each largely prevent penetration of light of one of the light emitting diodes (32a, 32b) into an optical device (44a, 44b) associated with another of the light emitting diodes for the focusing of the light radiated from the respective light emitting diode (32a, 32b).

22. A flashlight in accordance with claim 21, characterized in that the tubes (56a, 56b, 56c) are preferably designed such that the light of the corresponding light emitting diodes (32a, 32b) exiting them is substantially completely incident onto the corresponding associated optical device (44a, 44b) for the focusing of the light radiated from the respective light emitting diode (32a, 32b).

23. A flashlight in accordance with claim 21, characterized in that an interior surface of at least one of the tubes (56a, 56b, 56c) is non-reflective, preferably matted.

24. A flashlight in accordance with claim 21, characterized in that the interior space of at least one of the tubes (56a, 56b, 56c) is rotationally symmetrical.

25. A flashlight in accordance with claim 21, characterized in that the tubes (56a, 56b, 56c) are held on a base element (28) and their ends facing the light emitting diodes (32a, 32b) receive at least parts of the luminous body (33a, 33b) of the light emitting diodes (32a, 32b).

26. A flashlight in accordance with claim 25, characterized in that an end of at least one tube (56a, 56b, 56c) associated with a light emitting diode (32a, 32b) adjoins the optical device (44a, 44b) associated with this light emitting diode or an element holding said optical device.

27. A flashlight in accordance with claim 25, characterized in that the base element (28) and the tubes (56a, 56b, 56c) are made in one piece.

28. A flashlight in accordance with claim 21, characterized in that the optical devices (44a, 44b) for the focusing of the light radiated from the respective light emitting diodes are arranged inclined with respect to one another such that beams of light radiated by the light emitting diodes and formed in each case by the optical devices (44a, 44b) intersect in a pre-determined region.

29. A flashlight in accordance with claim 21, characterized in that a printed circuit board (30) holding the light emitting diodes (32a, 32b) is provided which has contact elements (36, 38) for contacting current carrying contacts (16) provided in the flashlight base body (10) or has batteries which can be inserted into the flashlight base body (10).

30. A flashlight in accordance with claim 29, characterized in that the contact elements (36, 38) include a first ring-shaped contact surface (36) and a second further substantially ring-shaped or circular contact surface (38) arranged inside the first contact surface (36).

31. A flashlight in accordance with claim 29, characterized in that the tubes (56a, 56b, 56c) are held on a base element (28) and their ends facing the light emitting diodes (32a, 32b) receive at least parts of the luminous body (33a, 33b) of the light emitting diodes (32a, 32b); and in that the base element (28) is arranged on the printed circuit board (30).

32. A flashlight in accordance with claim 21, characterized in that the optical devices (44a, 44b) for the focusing of the light radiated by the respective light emitting diodes are lenses (44a, 44b) which are integrated into a front element (26).

33. A flashlight in accordance with claim 29, characterized in that the optical devices (44a, 44b) for the focusing of the light radiated by the respective light emitting diodes are lenses (44a, 44b) which are integrated into a front element (26); in that the front element (26) is made in cup-like shape; and in that the tubes (56a, 56b, 56c) and the printed circuit board (30) with the light emitting diodes (32a, 32b) are arranged in the cup interior.

34. A flashlight in accordance with claim 25, characterized in that the optical devices (44a, 44b) for the focusing of the light radiated by the respective light emitting diodes are lenses (44a, 44b) which are integrated into a front element (26); and in that the front element (26) and the base element (28) or the printed circuit board (30) have mutually corresponding guide elements (40a, 40b, 40c, 52) which act as security against rotation.

35. A flashlight in accordance with claim 33, characterized in that the front element (26) and the printed circuit board (30) are connected to one another at the rim of the cup-like front element by a snap connection (64a, 64b).

36. A flashlight in accordance with claim 33, characterized in that the front element (26) with tubes (56a, 56b, 56c) and printed circuit board (30) are arranged in a sleeve-like head housing (24).

37. A flashlight in accordance with claim 36, characterized in that at least one lamp head seal (22), preferably a peripheral lamp head seal, is provided between the front element (26) and the head housing (28).

38. A flashlight in accordance with claim 21, characterized in that a seal, preferably a peripheral seal, is provided between the lamp head (12) and the flashlight base body (10).

39. A flashlight in accordance with claim 21, characterized in that the light emitting diodes (32a, 32b) are arranged on a circle at equal angular intervals.

40. A flashlight in accordance with claim 21, characterized in that three light emitting diodes (32a, 32b) are provided.
